(19) United States
(12) Patent Application Publication
(10) Pub. No.: US 2025/0230341 A1
(43) Pub. Date: Jul. 17, 2025

(54) CURABLE ADHESIVE COMPOSITIONS FOR BONDING ONE OR MORE SUBSTRATES

(71) Applicant: Henkel AG & Co. KGaA, Duesseldorf (DE)

(72) Inventors: Matthew Jay Quast, Sterling Heights, MI (US); Nicole Ann Murley, Madison Heights, MI (US); Alfred A Decato, Ashtabula, OH (US); Nicholas Thomas Kamar, Trenton, MI (US); Renuka Subhash Patil, Rochester Hills, MI (US); Martin Hornung, Rochester Hills, MI (US)

(21) Appl. No.: 19/013,232

(22) Filed: Jan. 8, 2025

Related U.S. Application Data
(63) Continuation of application No. PCT/US2023/068027, filed on Jun. 7, 2023.
(60) Provisional application No. 63/388,437, filed on Jul. 12, 2022.
(60) Provisional application No. 63/497,870, filed on Apr. 24, 2023.

(51) Int. Cl. C09J 4/00; B32B 7/12; B32B 15/08; B32B 15/18; B32B 15/20; C08F 290/04; C08F 290/06; C09J 151/00; C09J 151/04; C09J 151/08

(52) U.S. Cl. CPC C09J 4/00; B32B 7/12; B32B 15/08; B32B 15/18; B32B 15/20; C08F 290/046; C08F 290/048; C08F 290/067; C09J 151/003; C09J 151/04; C09J 151/08; B32B 2250/02; B32B 2255/06; B32B 2255/10; B32B 2255/205; B32B 2255/26; B32B 2307/412; B32B 2457/00

(57) ABSTRACT

A composition that cures when exposed to actinic radiation. In some embodiments the curable adhesive composition comprises: a) one or more radiation curable oligomers or prepolymers terminally having at least one carbon-carbon double bond-containing group; b) one or more diluent monomer components containing at least one polymerizable group; c) optionally one or more adhesion promoting additives of an organic or inorganic acid acrylic monomer; and optionally one or more rheological modifiers; one or more plasticizers and; one or more additives. The curable composition can be used in an adhesive that structurally bonds many substrates including dissimilar substrates. In some embodiments cured reaction products of the composition have a broad service temperature range from −20 to 120° C. Cured reaction products of this embodiment will exhibit greater than 50% cohesive failure in this temperature range. The cured composition will retain adhesive strength at temperatures above its Tg.

### FIELD

The present disclosure relates generally to compositions that cure when exposed to actinic radiation such as ultraviolet (UV) radiation.

### BRIEF DESCRIPTION OF RELATED TECHNOLOGY

Curable adhesive compositions are finding a wide range of applications in bonding, especially in the transportation and electronic industries. These industries bond many dissimilar substrates to form transportation components, for example aircraft, automotive, boat, rail and truck components and electronic devices, for example computers, mobile phones, tablets. Naturally, the transportation components and electronic devices would include subcomponents used in those components and devices.

One of the most difficult of all adhesive applications is the bonding of substrates with different coefficients of thermal expansion (CTE). Common examples include bonding aluminum to glass, glass to plastic, ceramic to plastic and rubber to metal. Additionally, stresses caused by temperature extremes in service and thermal cycling sometimes make a difficult situation more complicated.

This localized movement of materials, or thermal stress, concentrates at bond lines between the adhesive and substrate. It is important that the adhesive maintain sufficient bond strength while being flexible enough to survive these movements associated with thermocycling.

Bonding dissimilar substrate materials requires that an adhesive bond multiple surface chemistries and after curing can withstand stresses associated with varying coefficients of thermal expansion. To help minimize stress from thermally induced strains it is desired that the adhesive be flexible while maintaining adequate toughness for structural durability. In practice the flexibility of an adhesive can be manipulated from choice and concentration of prepolymers/oligomers, monomers, plasticizers, and filler loading.

Acrylic curable adhesive compositions contain multiple additives to help control properties in the uncured and cured state.

Plasticizers are a common ingredient used in many adhesive compositions owing to their ability to easily modulate workability of uncured adhesives and tailor physical attributes in cured adhesives. For cured adhesive compositions plasticizers function by embedding themselves between polymer chains which increases chain segment mobility and creates a dilution effect in the polymer matrix. By reducing rotational energy barriers in the polymer matrix the resulting cured composition benefits from improved flexibility. Moduli of elasticity, glass transition temperatures, tensile strength, and hardness are all reduced, whereas extension at break is increased. While plasticizers add flexibility and softness to an adhesive, that flexibility does not always last forever. Plasticizers tend to migrate out of the material resulting in embrittlement of the material. To try and mitigate plasticizer loss the structure and molecular weight of the plasticizer can be chosen accordingly.

Diluting monomers are commercially available in many chemical structures and properties which can be used to tailor the bulk properties and adhesive properties of a composition. For example, using monomers that are low-Tg and/or low-modulus will increase flexibility and using monomers that are high-Tg will increase the rigidity or modulus of a curable adhesive composition. Depending on the addition level or combination of the diluting monomers, the intended effect can be controlled. While effective to control these properties, there is trade off. For example, as concentration of a flexibilizing monomer is increased other properties such as high temperature toughness and adhesion strength decrease. For this reason, it can be difficult using monomers to balance the properties of an adhesive for bonding dissimilar substrates.

It remains a challenge to produce a flexible adhesive composition that retains high adhesive strength over a broad temperature range for bonding dissimilar substrates. Herein is disclosed an unexpected method by which to increase flexibility and adhesion strength over a large temperature range in curable compositions without the extensive use of plasticizers or other softening monomers.

### SUMMARY

One embodiment of the disclosure provides a curable adhesive composition comprising: a) one or more radiation curable oligomers or prepolymers terminally having at least one carbon-carbon double bond-containing group; b) one or more diluent monomer components containing at least one polymerizable group; c) optionally one or more adhesion promoting additives of an organic or inorganic acid acrylic monomer; d) optionally one or more rheological modifiers; e) optionally one or more plasticizers and; f) optionally one or more additives such as pigments, dyes, fillers, stabilizers, UV absorbers, antioxidants, process oils and the like.

One embodiment of the disclosure provides a curable adhesive composition having a broad service temperature range from −20 to 120° C. Cured reaction products of this embodiment will exhibit greater than 50% cohesive failure in this temperature range. The cured composition will retain adhesive strength at temperatures above its Tg.

One embodiment of the disclosure provides a curable adhesive composition that structurally bonds dissimilar substrates such as metal to plastic, in particular low surface energy aluminum and polycarbonate.

One embodiment of the disclosure provides a curable adhesive composition having extreme flexibility with a tensile modulus of less than 100 and elongation at break of greater than 200% at 23 degrees ° C. (ASTM D412).

### BRIEF DESCRIPTION OF THE DRAWINGS

FIG. 1 is a graph of T-Peel adhesion strength at 23° C. for samples on various substrates.

FIG. 2 is a graph of T-Peel adhesion strength at −20° C. for samples on various substrates.

FIG. 3 is a graph of T-Peel adhesion strength at −20° C. for samples on various substrates.

FIG. 4 is a graph of T-Peel adhesion strength at 120° C. for samples on various substrates.

FIG. 5 is a graph of T-Peel adhesion strength after 7 days exposure to 85° C./85% Relative Humidity for samples on various substrates.

FIG. 6 is a graph of T-Peel adhesion strength on steel substrate for various samples.

FIG. 7 is a graph of T-Peel adhesion strength on aluminum substrate for various samples at room temperature and after 7 days (1 week) exposure to 85° C./85% Relative Humidity.

FIG. 8 is a graph of T-Peel adhesion strength on bright tin plated CRS substrate for various samples at room temperature and after 7 days (1 week) exposure to 85° C./85% Relative Humidity.

FIG. 9 is a graph of T-Peel adhesion strength on copper substrate for various samples at room temperature and after 7 days (1 week) exposure to 85° C./85% Relative Humidity.

### DETAILED DESCRIPTION

The singular forms “a”, “an” and “the” include plural referents unless the context clearly dictates otherwise.

About or “approximately” as used herein in connection with a numerical value refer to the numerical value+10%, preferably +5% and more preferably +1% or less.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

The molecular weights given in the present text refer to number average molecular weights (Mn), unless otherwise stipulated. Molecular weight data can be obtained by gel permeation chromatography (GPC) calibrated against polystyrene standards in accordance with DIN 55672-1:2007-08 at 35° C., unless otherwise stipulated. The weight average molecular weight M_{w} can be determined by GPC, as described for Mₙ. “Polydispersity index” refers to a measure of the distribution of molecular mass in a given polymer sample. The polydispersity index is calculated by dividing the weight average molecular weight (Mw) by the number average molecular weight (Mn).

As used herein a curable, one component (1K) composition is a singular formulation that has sufficient commercial stability to be prepared, warehoused and shipped to an end-user. The 1K composition can be used without adding any additional components and will crosslink or cure when exposed to suitable conditions. As used herein a two component (2K) composition has two or more components. Each of the components is prepared, warehoused and shipped separately from the other components. The components are mixed immediately prior to use. Mixing of the components starts a cure reaction so commercial storage after mixing is not possible.

As used herein for each of the various embodiments, the following definitions apply:

Unless otherwise specifically defined, (meth)acrylate refers to at least one of acrylate and methacrylate. A “vinyl group” refers to (CH₂═CH—). A “(meth)acryloyl” refers to at least one of acryloyl and methacryloyl, an “acryloyl group” refers to (CH₂═CHCO—), and a “methacryloyl group” refers to (CH₂═C(CH₃)CO—).

Actinic radiation includes electron beam, ultraviolet light, visible light, and combinations thereof. Desirably, the actinic radiation used to cure the composition has a wavelength from about 200 nm to about 1,000 nm. Useful ultraviolet light (UV) includes, but is not limited to, UVA (about 320 nm to about 410 nm), UVB (about 290 nm to about 320 nm), UVC (about 220 nm to about 290 nm) and combinations thereof. Useful visible light includes, but is not limited to, blue light, green light, and combinations thereof. Such useful visible lights have a wavelength from about 450 nm to about 550 nm.

Unless otherwise specifically defined, “acyl” refers to the general formula —C(O)alkyl.

Unless otherwise specifically defined, “acyloxy” refers to the general formula —O-acyl.

Unless otherwise specifically defined, “alcohol” refers to the general formula alkyl-OH.

Unless otherwise specifically defined, “alkenyl” or “lower alkenyl” refers to a linear, branched or cyclic carbon chain having from 1 to about 16 carbon atoms, and advantageously about 1 to about 6 carbon atoms, and at least one double bond between carbon atoms in the chain. Examples include, for example, ethylene, allene, butene, butadiene, hexene, hexadiene, 5,5-dimethyl-1-hexene and cyclohexene. Unless otherwise specifically limited an alkenyl group can be unsubstituted, singly substituted, or multiply substituted, with substituent groups in any possible position.

Unless otherwise specifically defined, “alkoxy” refers to the general formula —O-alkyl.

Unless otherwise specifically defined, “alkyl” refers to a linear, branched or cyclic alkyl group having from 1 to about 9 carbon atoms including, for example, methyl, ethyl, propyl, butyl, hexyl, octyl, isopropyl, isobutyl, tert-butyl, cyclopropyl, cyclohexyl, cyclooctyl, vinyl and allyl. Unless otherwise specifically defined, an alkyl group can be saturated or unsaturated and substituted or unsubstituted. Unless otherwise specifically limited, a cyclic alkyl group includes monocyclic, bicyclic and polycyclic rings, for example norbornyl, adamantyl and related terpenes.

Unless otherwise specifically defined, “alkylamino” refers to the general formula-(NH)-alkyl.

Unless otherwise specifically defined, “di-alkylamino” refers to the general formula —N-(alkyl).sub.2. Unless otherwise specifically limited di-alkylamino includes cyclic amine compounds such as piperidine and morpholine.

Unless otherwise specifically defined, “alkylmercapto” refers to the general formula —S-alkyl.

Unless otherwise specifically defined, “alkynyl” or “lower alkynyl” refers to a linear, branched or cyclic carbon chain having from 1 to about 16 carbon atoms, and advantageously about 1 to about 6 carbon atoms, and at least one triple bond between carbon atoms in the chain. Examples include, for example, ethyne, butyne, and hexyne. Unless otherwise specifically limited an alkynyl group can be unsubstituted, singly substituted, or multiply substituted, with substituent groups in any possible position.

Unless otherwise specifically defined, an aromatic ring is an unsaturated ring structure having about 5 to about 6 ring members and including only carbon as ring atoms. Unless otherwise specifically defined, an aromatic ring can be substituted or unsubstituted.

Unless otherwise specifically defined, “aryl” refers to an aromatic ring system substituted or unsubstituted, that includes only carbon as ring atoms, for example phenyl, biphenyl or naphthyl.

Unless otherwise specifically defined, “aroyl” refers to the general formula —C(═O)-aryl.

Unless otherwise specifically defined, a carbocyclic ring is a ring structure having about 3 to about 8 ring members, substituted or unsubstituted, that includes only carbon as ring atoms, for example, benzene or cyclohexane.

The terms “halogen,” “halo” or “hal” when used alone or as part of another group mean chlorine, fluorine, bromine or iodine.

Unless otherwise specifically defined, a heteroaromatic ring is an unsaturated ring structure having about 5 to about 8 ring members, substituted or unsubstituted, that has carbon atoms and one or more heteroatoms, including oxygen, nitrogen and/or sulfur, as ring atoms. Heteroaromatic rings (or groups) also include fused polycyclic systems in which one or more monocyclic aromatic ring or monocyclic heteroaromatic ring is fused to another heteroaromatic ring. Examples of heteroaromatic rings (or groups) include but are not limited to, furan, thiophene, pyrrole, oxazole, thiazole, isoxazole, pyrazole, imidazole, oxadiazole, triazole, tetrazole, pyridine, pyrimidine, pyrazine, purine, benzothiazole, benzimibazole, benzofurane, indole, quinoline, quinoxaline.

Unless otherwise specifically defined “heteroaryl” refers to an heteroaromatic ring.

Unless otherwise specifically defined, a heterocyclic ring is a saturated ring structure having about 3 to about 8 ring members, substituted or unsubstituted, that has carbon atoms and one or more heteroatoms, including oxygen, nitrogen and/or sulfur, as ring atoms. Examples of heterocyclic rings include but are not limited to oxetane, thietane, azetidine, diazetidine, tetrahydrofuran, thiolane, pyrrolidine, dioxolane, oxathiolane, imidazolidine, dioxane, piperidine, morpholine, piperazine, and their derivatives. Unless otherwise specifically limited a heterocyclic ring includes monocyclic, bicyclic and polycyclic rings, for example azaadamantyl and tropanyl.

Unless otherwise specifically defined, the term “phenacyl” refers to the general formula-phenyl-acyl.

Room temperature refers a temperature of about 25° C.

Unless otherwise specifically limited the term substituted means substituted by at least one below described substituent group in any possible position or positions. Substituent groups for the above moieties useful in the disclosed compounds are those groups that do not significantly diminish the biological activity of the disclosed compound. Substituent groups that do not significantly diminish the biological activity of the disclosed compound include, for example, H, halogen, N₃, NCS, CN, NO₂, NX₁X₂, OX₃, C(X₄)₃, OAc, O-acyl, O-aroyl, NH-acyl, NH-aroyl, NHCOalkyl, CHO, C(halogen)₃, COOX₄, SO₃H, PO₃H₂, SO₂NX₁X₂, CONX₁X₂, C(O)CF₃, alkyl, alcohol, alkoxy, alkylmercapto, alkylamino, di-alkylamino, sulfonamide or thioalkoxy wherein X₁ and X₂ each independently comprise H or alkyl, or X₁ and X₂ together comprise part of a heterocyclic ring having about 4 to about 7 ring members and optionally one additional heteroatom selected from O, N or S, or X₁ and X₂ together comprise part of an imide ring having about 5 to about 6 members and X₄ comprises H, alkyl, loweralkylhydroxy, or alkyl-NX₁X₂. Unless otherwise specifically limited, a substituent group may be in any possible position or any possible positions if multiply substituted.

The term “aliphatic” means saturated or unsaturated, straight, branched or cyclic hydrocarbon groups;

The term “polymer” means a molecule having a small number of repeating monomer units such as 10-25,000 units which have been polymerized to form a molecule and includes oligomers and prepolymers which are a subset of the term polymer typically having a lesser number of repeating monomer units and degree of polymerization.

“One or more”, as used herein, relates to at least one and comprises 1, 2, 3, 4, 5, 6, 7, 8, 9 or more of the referenced species. Similarly, “at least one” means one or more, i.e. 1, 2, 3, 4, 5, 6, 7, 8, 9 or more. “At least one”, as used herein in relation to any component, refers to the number of chemically different molecules, i.e. to the number of different types of the referenced species, but not to the total number of molecules. For example, “at least one polyol” means that at least one type of molecule falling within the definition for a polyol is used but that also two or more different polyol types falling within this definition can be present but does not mean that only one type of said polyol is necessarily present.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

All percentages that are cited in connection with the compositions described herein refer to weight percent (wt. %) with respect to final composition with all components, unless stated otherwise.

In one embodiment the UV curable adhesive compositions comprise a (meth)acrylic prepolymer; a plasticizing adhesion promoting monomer; an adhesion promoting diluting monomer; a reactive monomer diluent; a photoinitiator; optional filler and optionally one or more additives. The UV curable adhesive composition is preferably a one component (1K) system and not a two component (2K) system.

### (Meth)Acrylic Prepolymer

Useful materials for use as the (meth)acrylic prepolymer include (meth)acrylic functional siloxanes, polyacrylates, polyurethanes, polyethers, polyolefins, polyesters, copolymers thereof and combinations thereof. In some embodiments the (meth)acrylic prepolymer is has at least two (meth)acryloyl functional groups, preferably pendant (meth)acryloyl functional groups. Desirably, the (meth)acryloyl pendant group is represented by —OC(O)C(R¹)═CH₂, where R¹ is hydrogen or methyl.

Preferably, the (meth)acrylic prepolymer is a (meth)acryloyl-terminated polyacrylate prepolymer having the below structure:

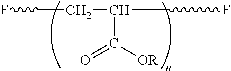

wherein each F moiety is the (meth)acryloyl pendant group is represented by —OC(O)C(R¹)—CH₂, where R¹ is hydrogen or methyl.

The (meth)acrylic prepolymer may desirably have a molecular weight (Mn) of less than 100,000 g/mol; and in some embodiments from about 3,000 to about 50,000 g/mol. Desirably the (meth)acrylic prepolymer has a molecular weight above about 16,000 g/mol to provide increased elongation and flexibility to cured reaction products of the adhesive composition. Further, the (meth)acrylic prepolymer may desirably have a viscosity from about 2,000 Pas (200,000 cPs) to about 8,000 Pas (800,000 cPs) at 25° C. (77° F.), more desirably from about 4,500 Pas (450,000 cPs) to about 5,000 Pas (500,000 cPs). The (meth)acrylic prepolymer is commercially available from Kaneka Corporation, Japan, such as under the trade designations RC220C, RC210C, RC200C and RC100C. It is believed that the RC220C, RC210C and RC200C are each terpolymers of combinations of substituted and unsubstituted alkyl acrylates, such as ethyl acrylate, 2-methoxyethyl acrylate and n-butyl acrylate (varying by molecular weight), whereas the RC100C is a homopolymer of n-butyl acrylate.

### Plasticizing Adhesion Promoting Monomer.

The plasticizing adhesion promoting monomer adds flexibility to cured reaction products of the adhesive composition and also aids in adhesion of cured reaction products of the adhesive composition to substrates. The plasticizing adhesion promoting monomer also covalently bonds into the polymer network of the cured composition. Useful as the plasticizing adhesion promoting monomer are acrylic acid, methacrylic acid and combinations thereof. Currently, no other materials that can be used as a plasticizing adhesion promoting monomer in this composition are known to the inventors. Use of large amounts of plasticizing adhesion promoting monomer is not desirably as it has a deleterious effect on cured product modulus and humidity resistance.

### Adhesion Promoting Diluting Monomer

The adhesion promoting diluting monomer lowers viscosity of the uncured adhesive composition and also aids in adhesion of cured reaction products of the adhesive composition to substrates. The plasticizing adhesion promoting monomer also covalently bonds into the polymer network of the cured composition. N,N-dimethylacrylamide has proven useful for use as the adhesion promoting diluting monomer. Currently, no other materials that can be used as an adhesion promoting diluting monomer in this composition are known to the inventors.

### Reactive Monomer Diluent

The reactive monomer diluent adds flexibility to cured reaction products of the adhesive composition. The reactive monomer diluent also covalently bonds into the polymer network of the cured composition. The reactive monomer diluent will not be (meth)acrylic acid or dimethylacrylamide. Useful as the reactive monomer diluent are monomers having one or more one or more reactive (meth)acrylate groups. Preferably, the reactive monomer diluent is a monofunctional (meth)acrylate as these allow the cured reaction products of the composition to have increased elongation. Useful monofunctional (meth)acrylates may be embraced by the general structure CH₂═C(R)COOR² where R is H, CH₃, C₂H₅ or halogen, such as Cl, and R² is a molecule backbone comprising C₁₋₈ mono- or bicycloalkyl, a 3 to 8-membered heterocyclic radial with a maximum of two oxygen atoms in the heterocycle, H, alkyl, hydroxyalkyl or aminoalkyl where the alkyl portion is C₁₋₂₀ straight, branched or cyclic carbon atom chain. Among the specific monofunctional (meth)acrylate monomers particularly desirable, and which correspond to certain of the structures above, are hydroxypropyl (meth)acrylate, 2-hydroxyethyl (meth)acrylate, methyl (meth)acrylate, tetrahydrofurfuryl (meth)acrylate, cyclohexyl (meth)acrylate, 2-aminopropyl (meth)acrylate, isobornyl (meth)acrylate, isodecyl (meth)acrylate, and 2-ethyl hexyl (meth)acrylate. In addition, β-carboxyethyl acrylate (such as is available commercially from Rhodia under the tradename SIPOMER) are usefully employed in the practice of the present invention. Combinations of 2 or more of the above monofunctional (meth)acrylates can be used.

In some embodiments it is useful for the reactive monomer diluent to have a high glass transition temperature (Tg) of 50° C. or more and/or be hydrophobic.

A reactive monomer diluent having a high Tg provides cured reaction products of the curable composition with increased strength and improved modulus.

A reactive monomer diluent having hydrophobicity provides cured reaction products of the curable composition with improved bond strength durability and resistance to humidity in the application environment. One indication of reactive monomer diluent hydrophobicity is for the molecule backbone to have a C atom to O atom ratio of greater than 3:1 and preferably greater than 4:1.

### Relationship of the Plasticizing Adhesion Promoting Monomer to Adhesion Promoting Diluting Monomer

The plasticizing adhesion promoting monomer will be used at a weight ratio of 1 plasticizing adhesion promoting monomer:4 adhesion promoting diluting monomer to 1 plasticizing adhesion promoting monomer:20 adhesion promoting diluting monomer. The cured reaction products of adhesive compositions prepared using plasticizing adhesion promoting monomer:adhesion promoting diluting monomer ratios outside of these ranges may not provide satisfactory substrate adhesive strength, tensile modulus and/or bond durability during exposure to humid environments.

### Relationship of the Plasticizing Adhesion Promoting Monomer to Reactive Monomer Diluent

The adhesion promoting diluting monomer will be used at a weight ratio of 3 adhesion promoting diluting monomer:2 reactive monomer diluent to 1 adhesion promoting diluting monomer:2 reactive monomer diluent. The cured reaction products of adhesive compositions prepared using adhesion promoting diluting monomer:reactive monomer diluent ratios outside of these ranges may have decreased substrate adhesive strength and/or bond durability during exposure to humid environments.

### Photoinitiator

Photoinitiators enhance the rapidity of the curing process when the curable composition is exposed to actinic radiation. Desirably, the photoinitiator is added to the composition in an amount effective to respond to the actinic radiation and to initiate and induce curing of the composition.

Suitable photoinitiators useful with ultraviolet (UV) actinic radiation curing mono- and polyolefinic monomers include free radical generating UV initiators such as substituted benzophenones and substituted acetophenones, benzoin and its alkyl esters and xanthone and substituted xanthones. Photoinitiators include diethoxy-acetophenone, benzoin methyl ether, benzoin ethyl ether, benzoin isopropyl ether, diethoxyxanthone, chloro-thio-xanthone, azo-bisisobutyronitrile, N-methyl diethanol-amine-benzophenone and mixtures thereof. Particular examples of suitable photoinitiators for use herein include, but are not limited to, photoinitiators available commercially from Ciba Specialty Chemicals, under the “IRGACURE” and “DAROCUR” trade names, specifically IRGACURE 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4,4-trimethyl pentyl) phosphine oxide and 2-hydroxy-2-methyl-1-phenyl-propan-1-one), 819 [bis(2,4,6-trimethyl benzoyl) phenyl phosphine oxide], 2022 [IRGACURE 819 dissolved in DAROCUR 1173 (described below)] and DAROCUR 1173 (2-hydroxy-2-methyl-1-phenyl-1-propan-1-one) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and IRGACURE 784DC. Of course, combinations of these materials may also be employed herein. Other photoinitiators useful herein include alkyl pyruvates, such as methyl, ethyl, propyl, and butyl pyruvates, and aryl pyruvates, such as phenyl, benzyl, and appropriately substituted derivatives thereof. Photoinitiators particularly well-suited for use herein include ultraviolet photoinitiators, such as 2,2-dimethoxy-2-phenyl acetophenone (e.g., IRGACURE 651), and 2-hydroxy-2-methyl-1-phenyl-1-propane (e.g., DAROCUR 1173), bis(2,4,6-trimethyl benzoyl) phenyl phosphine oxide (e.g., IRGACURE 819 and IRGACURE 2022), and the ultraviolet/visible photoinitiator combination of bis(2,6-dimethoxybenzoyl-2,4,4-trimethylpentyl) phosphine oxide and 2-hydroxy-2-methyl-1-phenyl-propan-1-one (e.g., IRGACURE 1700), as well as the visible photoinitiator bis(5-2,4-cyclopentadien-1-yl)-bis [2,6-difluoro-3-(1H-pyrrol-1-yl)phenyl]titanium (e.g., IRGACURE 784DC).

In some applications LED devices are used to generate UV radiation to cure compositions. LED devices have advantages such as cooler run temperatures and lower energy use compared to older mercury vapor technology. However, LED devices typically emit UV radiation at 395 nm and higher. In some applications these high UV radiation wavelengths may lead to undesirable lower cure rates and cure levels in compositions when used with convention photoinitiators. Type II photosensitizers such as Esacure 1001M, Esacure ONE, ITX, have proven useful in curing compositions exposed to LED generated radiation and are preferred for this application.

### Additives

The composition can optionally include one or more additives. Useful additives for the composition can include filler, adhesion promoters for example organo functional siloxane adhesion promoter such as 3-aminopropyltrimethoxysilane and/or 3-methacryloxypropyltrimethoxysilane; thixotropes and rheological auxiliaries such as hydrogenated castor oil, fatty acid amides or swellable plastics such as PVC; non-reactive diluents; non-reactive plasticizers such as phthalates, reactive and non-reactive thermoplastic polymer including acrylic polymer, functional (e.g. containing reactive moieties such as —OH and/or —COOH) acrylic polymer, non-functional acrylic polymer, acrylic block copolymer, acrylic polymer having tertiary-alkyl amide functionality, polysiloxane polymer, polystyrene copolymer, divinylbenzene copolymer, polyetheramide, polyvinyl acetal, polyvinyl butyral, polyvinyl chloride, methylene polyvinyl ether, cellulose acetate, styrene acrylonitrile, amorphous polyolefin, olefin block copolymer [OBC], polyolefin plastomer, thermoplastic urethane, polyacrylonitrile, ethylene acrylate copolymer, ethylene acrylate terpolymer, ethylene butadiene copolymer and/or block copolymer, and styrene butadiene block, such as the Elvacite resins available from Mitsubishi Chemical America; antioxidant such as hindered amines and/or hindered phenols; alkoxy silane moisture scavengers such as vinyltrimethoxysilane; colorant, and fluorescent dye.

The additive fillers can include, for example, inorganic fillers such as chalk, powdered limestone, precipitated and/or pyrogenic silica, zeolite, bentonite, carbonates such as calcium carbonate and magnesium carbonate, sulfates such as barium sulfate, kieselguhr, alumina, clay, titanium oxide, iron oxide, zinc oxide, sand, quartz, flint, mica, powdered glass, metal powder, other ground minerals, silane treated silica, (meth)acrylate treated silica; organic materials such as carbon black, graphite, wood fiber, wood flour, sawdust, cellulose, cotton, pulp, wood chips, chopped straw, chaff, ground walnut shell and other short-cut organic fibers; short fibers such as glass fibers, glass filament, polyacrylonitrile, carbon fibers, Kevlar fibers or polyethylene fibers; hollow spheres with a mineral shell or a plastic shell such as Glass Bubbles®, Expancel® or Dualite® materials. Combinations of the above fillers can also be useful.

In some embodiments the curable composition has the following components and ranges. Ranges are in wt. % based on the weight of the composition.

| | | | |
|---|---|---|---|
| (meth)acrylic | 10-90% | 20-75% | 20-55 |
| prepolymer | | | |
| adhesion promoting | 1.0-50% | 8-35% | 12-25 |
| diluting monomer | | | |
| reactive monomer | 0-50% | 4-35 | 5-25 |
| diluent | | | |
| plasticizing adhesion | 0.01-20% | 0.01-10% | 0.1-5 |
| promoting monomer | | | |
| photoinitiator | 0.1-5% | 0.2-3% | 0.5-1 |
| filler | 0-40% | 0-30% | 5-15 |
| additives | 0-40% | 0-30% | 1-20 |

In some embodiments use of less than 10 wt. % of the adhesion promoting diluting monomer by weight of curable composition provides a lower bond strength to some plastic substrates. In some embodiments using more than 25 wt. % of the adhesion promoting diluting monomer by weight of curable composition increases hygroscopic tendencies of the curable composition.

Using some plasticizing adhesion promoting monomer in the curable composition provides cured reaction products of that composition with a higher modulus and increased humidity resistance. However, use of more than about 5 wt. % of the plasticizing adhesion promoting monomer by weight of curable composition provides little or no benefit while increasing cost. In some embodiments the curable composition will comprise 5 wt. % or less and preferably 2 wt. % or less of the plasticizing adhesion promoting monomer by weight of the composition.

The components are homogeneously mixed into a curable composition. Typically mixing starts with the prepolymer and monomers, with additives, filler and photoinitiator subsequently added and mixed. The mixed composition should be packaged to exclude actinic radiation to avoid premature cure initiation. The uncured composition can have a viscosity of 1 to 100 Pas. In some embodiments where the curable composition is extruded during application a viscosity of about 5 to 50 Pas is more preferable. Naturally, the viscosity will be adjusted to suit the application method and application.

In use the curable composition is disposed on a surface of a first substrate and a second substrate is placed over the first substrate with a surface in contact with the disposed adhesive. One of the substrates is at least partially transparent to actinic radiation. Actinic radiation is provided thorough the radiation transparent substrate to initiate a cure reaction in the curable composition. Preferably the cured composition will have an irreversible solid form with a generally non-tacky feel. Preferably, the cured composition is not a pressure sensitive adhesive. Once the composition is cured it will bond the first substrate to the second substrate. Typical substrates include any combination of ceramic, glass, polymer and metal. The combination of different monomers make the curable compositions especially useful for bonding a polymer substrate to a non-polymer substrate such as metal.

In some embodiments the plasticizing effect of the monomer combination and monomer ratios and prepolymer allows the cured reaction products of the curable adhesive composition to retain bond strength and flexibility over a broad temperature range (−20 to 120° C.). This makes the curable composition suitable for bonding substrate combinations with different expansion rates such as polymer to metal.

In some embodiments the monomer combination and monomer ratios and prepolymer allows the cured reaction products to retain flexibility and bond strength over a range of humidity conditions. This makes the curable composition suitable for bonding substrates that will be exposed to high temperatures and high relative humidity during use. Preferably, the cured composition can maintain at least 60% of the normal cured strength after being exposed to 85° C. and 85% relative humidity for one week (7 days).

The following examples are included for purposes of illustration so that the disclosure may be more readily understood and are in no way intended to limit the scope of the disclosure unless otherwise specifically indicated.

The proceeding description is meant to be exemplary and it is to be understood that variations and modifications may be employed without departing from the concept and intent of the invention as defined in the following claims.

Viscosity was tested using a parallel plate or cone-plate rheometer such as Anton Paar MCR 302, using a 50-mm diameter cone or a 25-mm diameter parallel plate at 25 degrees C.

Samples were prepared by spreading adhesive with 1 mm glass spacer beads on one substrate surface and disposing a second substrate surface on the spread adhesive to provide two substrates with a 1 mm thick layer of adhesive therebetween. The disposed adhesive was cured by exposure to UV light. After the samples were cured, they were tested.

Ultraviolet (UV) curing was conducted using a UV-LED array (375 nm or 405 nm), each having an UV irradiation energy of about 700 mW/cm2 or more.

After curing, some cured reaction products were held for 7 days (1 week) in a chamber maintained at 85° C. and 85% RH. Further tests were run on these samples after this exposure.

Peel strength is measured using a modification of ASTM D1876. A transparent plastic substrate is bonded to a metal substrate using a 1 mm adhesive layer between the substrates. The adhesive is cured by exposure to an LED source through the plastic substrate for 60 seconds. The source has an emission of about 405 nm at 700 mW/cm2. After curing the free surface of the plastic substrate is boned to a metal plate using a structural MMA adhesive such as Loctite AA H3500. Once the adhesive is cured the metal plate and metal substrate are placed in a tensile test machine and pulled at a rate of 50 mm/min. Peel strength is measured and the failure mode is also examined visually by estimating the total bond area where adhesive remains on the bonding surfaces of the plastic substrate and metal substrate. Failure mode is reported as % cohesive failure.

Tensile strength at break, elongation at break and tensile modulus are evaluated under ASTM D412.

Glass transition temperature (Tg) is evaluated using ASTM E1640-04) and is the peak of tan delta measured using a TA Instruments DMA Q800. While there may be multiple Tg peaks for the cured composition, the relevant Tg will be that of the overall cured composition. This is labeled as Tg2. Some plasticizing adhesion promoters when added to the composition will lower the Tg2. This is called the Tg2 depression effect.

### Example 1: Prophetic Compositions

An adhesive composition may be prepared from a mixture of (meth)acrylic prepolymer (300-600 g); an adhesion promoting diluting monomer (100-250 g); a reactive monomer diluent (100-250 g); a plasticizing adhesion promoting monomer (1-50 g); optionally a toughening filler (20-150 g); a photoinitiator (2-10 grams). In some embodiments one or more optional additives can be added to the above composition, for example a preservative; an antioxidant such as hindered phenols (0.5-5 g) or hindered amines (1-50 g); a colorant or pigment or fluorescent dye (0.01-1 g); and non-bonding plasticizer such as phthalates (1-100 g).

The prophetic mixture would be a 1 k system that would be useful for bonding dissimilar substrates such as polymer to metal. In one use the mixture could be disposed between and in contact with the bonding surfaces of adjacent substrates and cured to bond those substrates. The prophetic Example 1 material could be cured by exposure to actinic radiation such as UV light, preferably UV radiation from an LED source having a wavelength from about 390 nm or greater. Cured reaction products of the prophetic Example 1 material is expected to have a flexible structure with plasticization by the high Tg reactive monomer diluent helping to retain toughness at high temperatures while permitting cohesive failure at low temperatures.

### Example 2: Prepolymer Type and Influence on Physical Properties

Curable compositions were prepared using various prepolymer types with and without plasticizing adhesion promoting monomer. All amounts are in wt. % by weight of the composition. To compare plasticization effects the following properties were measured: modulus at 23° C., modulus 120° C. and glass transition temperature (Tg). Compositions and data are shown in the following tables.

| | | Tg2 | | | | | | |
|---|---|---|---|---|---|---|---|---|
| | MW | depression | sample | | | | | |
| | (Mn) | effect | 1a | 1b | 2a | 2b | 3a | 3b |
| Telechelic | | N | 41.0 | 41.0 | | | | |
| Polyurethane | | | | | | | | |
| Telechelic | 4450 | N | | | 41.0 | 41.0 | | |
| Polybutadiene | | | | | | | | |
| Telechelic | 13600 | N | | | | | 41.0 | 41.0 |
| Polyacrylate | | | | | | | | |
| Telechelic | 16700 | N | | | | | | |
| Polyacrylate | | | | | | | | |
| Telechelic | 25200 | Y | | | | | | |
| Polyacrylate | | | | | | | | |
| Telechelic | 32600 | Y | | | | | | |
| Polyacrylate | | | | | | | | |
| adhesion | | | 23.0 | 23.0 | 23.0 | 23.0 | 23.0 | 23.0 |
| promoting | | | | | | | | |
| diluting | | | | | | | | |
| monomer¹ | | | | | | | | |
| reactive | | | 21.5 | 21.5 | 21.5 | 21.5 | 21.5 | 21.5 |
| monomer | | | | | | | | |
| diluent² | | | | | | | | |
| filler⁴ | | | 7.5 | 7.5 | 7.5 | 7.5 | 7.5 | 7.5 |
| additive⁵ | | | 1.0 | 1.0 | 1.0 | 1.0 | 1.0 | 1.0 |
| photoinitiator⁶ | | | 0.5 | 0.5 | 0.5 | 0.5 | 0.5 | 0.5 |
| plasticizing | | | 0 | 2 | 0 | 2 | 0 | 2 |
| adhesion | | | | | | | | |
| promoting | | | | | | | | |
| monomer³ | | | | | | | | |
| Tg2 tan delta | MPa | | 108 | 116 | 56 | 61 | 45 | 84 |
| N −20 modulus | MPa | | 1490 | 1067 | 732 | 852 | 1320 | 1101 |
| 23 C. Modulus | MPa | | 1000 | 737 | 208 | 296 | 163 | 250 |
| 65 C. Modulus | MPa | | 440 | 433 | 15 | 32 | 1.7 | 33 |
| 85 C. Modulus | MPa | | 133 | 219 | 6.7 | 14 | 1 | 8 |
| 120 C. Modulus | MPa | | 10 | 13.1 | 4.4 | 6.8 | 0.9 | 3 |

¹N,N-dimethylacrylamide
²isobornyl acrylate
³acrylic acid
⁴silane treated fumed silica
⁵antioxidant, colorant
⁶Omnirad 819

| | | Tg2 | | | | | | |
|---|---|---|---|---|---|---|---|---|
| | MW | depression | sample | | | | | |
| | (Mn) | effect | 4a | 4b | 5a | 5b | 6a | 6b |
| Telechelic | | N | | | | | | |
| Polyurethane | | | | | | | | |
| Telechelic | 4450 | N | | | | | | |
| Polybutadiene | | | | | | | | |
| Telechelic | 13600 | N | | | | | | |
| Polyacrylate | | | | | | | | |
| Telechelic | 16700 | N | 41.0 | 41.0 | | | | |
| Polyacrylate | | | | | | | | |
| Telechelic | 25200 | Y | | | 41.0 | 41.0 | | |
| Polyacrylate | | | | | | | | |
| Telechelic | 32600 | Y | | | | | 41.0 | 41.0 |
| Polyacrylate | | | | | | | | |
| adhesion | | | 23.0 | 23.0 | 23.0 | 23.0 | 23.0 | 23.0 |
| promoting | | | | | | | | |
| diluting | | | | | | | | |
| monomer¹ | | | | | | | | |
| reactive | | | 21.5 | 21.5 | 21.5 | 21.5 | 21.5 | 21.5 |
| monomer | | | | | | | | |
| diluent² | | | | | | | | |
| filler⁴ | | | 7.5 | 7.5 | 7.5 | 7.5 | 7.5 | 7.5 |
| additive⁵ | | | 1.0 | 1.0 | 1.0 | 1.0 | 1.0 | 1.0 |
| photoinitiator⁶ | | | 0.5 | 0.5 | 0.5 | 0.5 | 0.5 | 0.5 |
| plasticizing | | | 0 | 2 | 0 | 2 | 0 | 2 |
| adhesion | | | | | | | | |
| promoting | | | | | | | | |
| monomer³ | | | | | | | | |
| Tg2 tan delta | ° C. | | 68.5 | 101.3 | 90.2 | 58.8 | 82 | 50.3 |
| N −20 modulus | MPa | | 870 | 1211 | 2000 | 1420 | 1320 | 2070 |
| 23 C. Modulus | MPa | | 231 | 291 | 403 | 106 | 163 | 70 |
| 65 C. Modulus | MPa | | 6.5 | 73 | 15 | 32 | 1.7 | 10.8 |
| 85 C. Modulus | MPa | | 1.4 | 20 | 7.7 | 6.4 | 1 | 4.8 |
| 120 C. Modulus | MPa | | 0.5 | 1.9 | 0.7 | 1.9 | 0.7 | 1.5 |

¹N,N-dimethylacrylamide
²isobornyl acrylate
³acrylic acid
⁴silane treated fumed silica
⁵antioxidant, colorant
⁶Omnirad 819

Example 2 illustrates the effectiveness of using acrylic acid in the above compositions to lower modulus and Tg of the composition reaction products. Six different prepolymers were used to compare the effect no acrylic acid (a series) and including acrylic acid (b series). In general, the effectiveness is better when polymer systems having a molecular weight of 16 kDa (Mn) or more are used.

Sample 1: When an aliphatic polyurethane is used as prepolymer the acrylic acid monomer lowers the 23° C. modulus, however, Tg is increased as expected.

Sample 2: Telechelic polybutadiene with MW of 4450 Da does not illustrate any softening effect.

Sample 3: Telechelic polyacrylate with MW of 13600 does not illustrate any softening effect.

Sample 4: Telechelic polyacrylate with MW of 16700 does not illustrate any softening effect.

Sample 5: Telechelic polyacrylate with MW of 25200 illustrates an unexpected and surprising softening effect when acrylic acid is added to the composition. The material is softened at temperatures below the Tg and hardened at temperatures above the Tg.

Sample 6: Telechelic polyacrylate with MW of 32600 illustrates an unexpected and surprising softening effect when acrylic acid is added to the composition. The material is softened at temperatures below the Tg and hardened at temperatures above the Tg.

### Example 3: Plasticization of (Meth)Acrylic Prepolymer by Different Materials

Curable compositions were prepared using the same (meth)acrylic prepolymer with the plasticizing adhesion promoting monomer and different candidate plasticizing materials. Example 3 compares the plasticization effects of various materials incorporated in a UV curable adhesive system comprising a (meth)acrylic prepolymer that is 3-33 kDa. Tg, modulus, and peel behavior were tested to evaluate the plasticizing effect. All amounts shown below are in grams.

| | sample | | | | |
|---|---|---|---|---|---|
| | 7 | 8 | 9 | 10 | 11 |
| (meth)acrylic prepolymer¹ | 41.0 | 41.0 | 41.0 | 41.0 | 41.0 |
| adhesion promoting diluting | 23.0 | 23.0 | 23.0 | 23.0 | 23.0 |
| monomer² | | | | | |
| reactive monomer diluent³ | 21.5 | 21.5 | 21.5 | 21.5 | 21.5 |
| filler⁴ | 7.5 | 7.5 | 7.5 | 7.5 | 7.5 |
| additive⁵ | 1.0 | 1.0 | 1.0 | 1.0 | 1.0 |
| Photoinitiator⁶ | 0.5 | 0.5 | 0.5 | 0.5 | 0.5 |
| plasticizing adhesion promoting | 0 | 2.0 | — | — | — |
| monomer 1⁷ | | | | | |
| Plasticizing adhesion promoting | — | — | 2.0 | — | — |
| monomer 2⁸ | | | | | |
| Plasticizing nonreactive diluent⁹ | — | — | — | 2.0 | — |
| Plasticizing reactive monomer | — | — | — | — | 2.0 |
| diluent¹⁰ | | | | | |
| Tg measure by tanδ in DMA (° C.) | 82 | 50 | 45 | 81 | 86 |
| Modulus at −20° C. (MPa) | 2200 | 2070 | 1540 | 2078 | 666 |
| Modulus at 23° C. (MPa) | 369 | 70 | 69 | 420 | 127 |
| Modulus at 120° C. (MPa) | 0.7 | 1.5 | 1.2 | 0.5 | 0.73 |

¹RC 310C 33 kDa available from Kaneka
²N,N-dimethylacrylamide
³isobornyl acrylate
⁴fumed silica
⁵antioxidant
⁶Omnirad 819
⁷acrylic acid
⁸2-carboxyethyl acrylate (Beta-CEA)
⁹2-hydroxyethylmethacrylate, mono- and di-phosphate esters
⁹tricresyl phosphate (TCP)
¹⁰isooctyl acrylate

Sample 7 is a composition with no plasticizing material added to establish a baseline.

Sample 8 is the baseline composition further comprising acrylic acid as plasticizing adhesion promoting monomer. The sample 8 results show that acrylic acid depresses Tg of the cured composition with the cured reaction products being softer at temperatures below the Tg and harder at temperatures above the Tg compared to sample 7.

Sample 9 is the baseline composition further comprising 2-carboxyethyl acrylate (Beta-CEA) as a possible plasticizing adhesion promoting monomer. Beta-CEA is a carboxylic-acid containing monomer which has a homopolymer Tg of approximately 15.4° C. (measured by DSC). Beta-CEA also reduced the cured reaction product Tg, which is expected for a monomer with a lower Tg than the baseline composition. What is surprising about sample 9 is the potent effect that beta-CEA has, reducing the Tg more significantly than would be expected with an alternative low Tg monomer at the same loading (see sample 11).

Sample 10 is the baseline composition further comprising tricresyl phosphate, a known plasticizer. Cured reaction products of the sample 10 composition showed no change in Tg and little change in modulus.

Sample 11 is the baseline composition further comprising isooctyl acrylate. Isooctyl acrylate was chosen because it has a low homopolymer Tg of −54 degrees C., and which is used in the field to lower the Tg of an adhesive composition as an alternative to plasticizer e.g. it behaves a plasticizing monomer because of its low Tg. Cured reaction products of the sample 11 composition had minimal change in Tg compared to the control, indicating that isooctyl acrylate does not demonstrate the unique, potent Tg depression effect observed with acrylic acid or beta-CEA in samples 8 and 9.

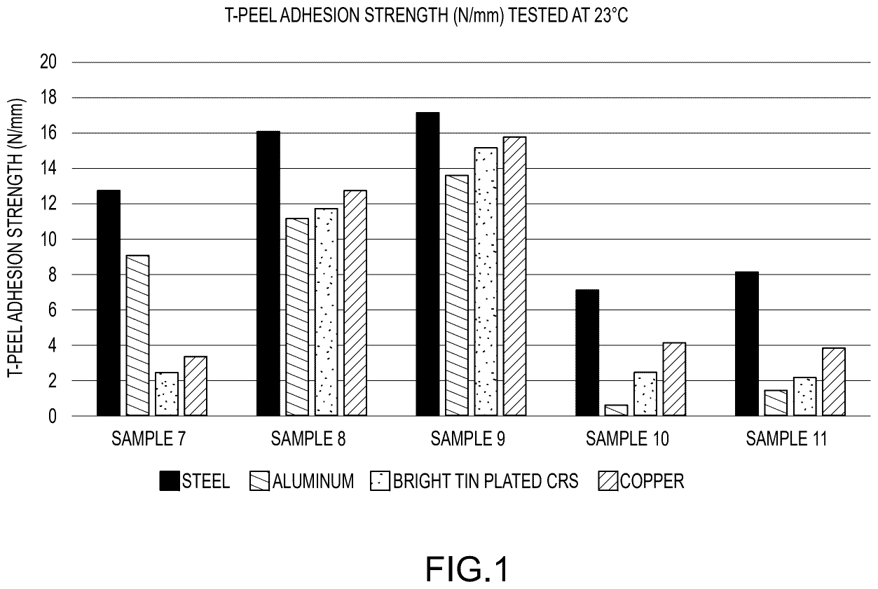

The T-Peel adhesion strength of the prepared compositions in Example 3 were tested with 1 mm of adhesive applied between a metal substrate and a UV-transparent plastic substrate, cured with 405 nm LED radiation at 0.8 W/cm2 for 60 seconds. The following metal substrates were tested: Steel, ground on one side, grade RS-14 from Q-Lab (“Steel”); Aluminum 2024T3 bare grade AR-14 from Q-Lab (“Aluminum”); Bright tin plated CRS, minimum 0.002″ plating from ACT Test Panels LLC (“Bright Tin Plated CRS”); and Copper sheet C110 from Online Metals (“Copper”). The UV-transparent plastic substrate used to bond to the metal substrate is Sabic Lexan LS2-111 Polycarbonate from Standard Plaque Inc. The ambient (23° C.) T-Peel adhesion strength data for the compositions in Example 3 are reported below. All values are reported in N/mm. Results are also shown in FIG. 1.

T-Peel Adhesion Strength (N/mm) Tested at 23° C.

| Substrate | 7 | 8 | 9 | 10 | 11 |
|---|---|---|---|---|---|
| Steel | 12.8 | 16.1 | 17.2 | 7.1 | 8.2 |
| Aluminum | 9.1 | 11.1 | 13.6 | 0.6 | 1.5 |
| Bright Tin Plated CRS | 2.5 | 11.7 | 15.2 | 2.5 | 2.2 |
| Copper | 3.4 | 12.7 | 15.8 | 4.2 | 3.9 |

At 23° C., Samples 8 and 9, which contain the plasticizing adhesion promoting monomers, demonstrate the highest adhesive strength. Sample 7, which contains no plasticizing component, demonstrates similar adhesive strength to steel and aluminum but a reduced adhesion strength to bright tin plated CRS and copper. Samples 10 and 11 demonstrate that the addition of other types of plasticizing agents, either reactive or nonreactive, cause an overall loss in adhesion strength at this test temperature.

In addition to ambient temperature (23° C.) performance, adhesives must be able to perform under a broad temperature range depending on the exposure of the target application. T-peel adhesion testing was conducted at −20° C. and 120° C. to demonstrate superior performance of the compositions containing the plasticizing adhesion promoting monomers.

T-Peel Adhesion Strength (N/mm) Tested at −20° C.

| Substrate | 7 | 8 | 9 | 10 | 11 |
|---|---|---|---|---|---|
| Steel | 0 | 22.8 | 1.0 | 0 | 0 |
| Aluminum | 0 | 17.0 | 21.6 | 0 | 0 |
| Bright Tin Plated CRS | 8.9 | 14.7 | 19.7 | 0 | 6.1 |
| Copper | 5.9 | 9.4 | 15.1 | 2.6 | 4.7 |

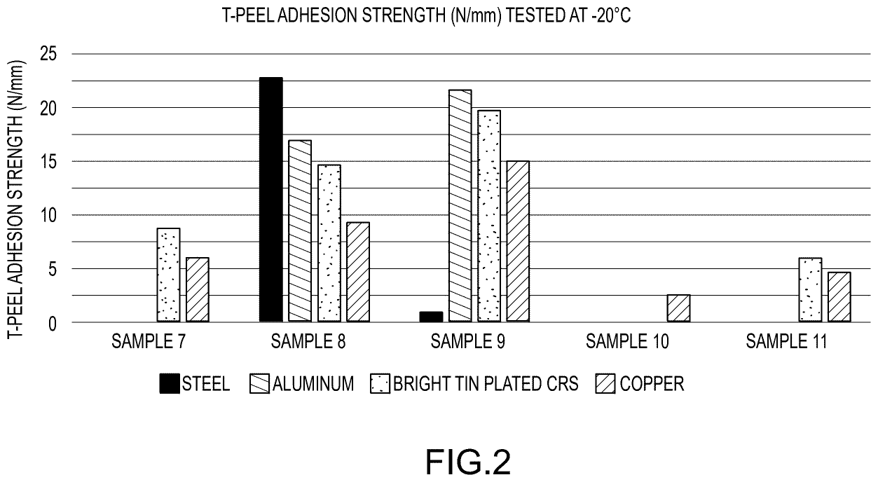

Results are shown in FIG. 2.

When tested at −20° C., the plasticizing adhesion promoting monomers in samples 8 and 9 provide adhesion strength over double that of the baseline and of other plasticizing additives.

To further highlight the importance of the surprising plasticization property of (meth)acrylic acid and B-CEA, their adhesion via T-Peel test is compared to a sample 12, containing the baseline composition further comprising a 2-hydroxyethyl methacrylate ester of phosphoric acid (HEMA Phosphate). This is a common adhesion promoter in the field that does not impart the surprising Tg reduction quality of (meth)acrylic acid or B-CEA. The overall modulus of the cured composition is lower than the baseline but the Tg is higher than the baseline. All amounts shown below are in grams.

sample 12

| | |
|---|---|
| (meth)acrylic prepolymer¹ | 41.0 |
| adhesion promoting diluting monomer² | 23.0 |
| reactive monomer diluent³ | 21.5 |
| filler⁴ | 7.5 |
| additive⁵ | 1.0 |
| photoinitiator⁶ | 0.5 |
| Plasticizing adhesion promoting monomer 1⁷ | — |
| Plasticizing adhesion promoting monomer 2⁸ | — |
| Plasticizing nonreactive diluent⁹ | — |
| Plasticizing reactive monomer diluent¹⁰ | — |
| Non-plasticizing adhesion promoting monomer¹¹ | 2 |
| Tg measure by tanδ in DMA (° C.) | 90 |
| Modulus at −20° C. | 960 |
| Modulus at 23° C. | 133 |
| Modulus at 120° C. | 1.4 |

¹¹phosphoric acid, 2-hydroxyethyl methacrylate ester (HEMA Phosphate)

T-Peel adhesion at −20° C. for sample 12 was compared to samples 8 and 9 with results shown in the Table below.

T-Peel Adhesion Strength (N/mm) Tested at −20° C.

| | sample | | |
|---|---|---|---|
| Substrate | 8 | 9 | 12 |
| Steel | 22.8 | 1.0 | 0 |
| Aluminum | 17.0 | 21.6 | 0 |
| Bright Tin Plated CRS | 14.7 | 19.7 | 9.4 |
| Copper | 9.4 | 15.1 | 1.3 |

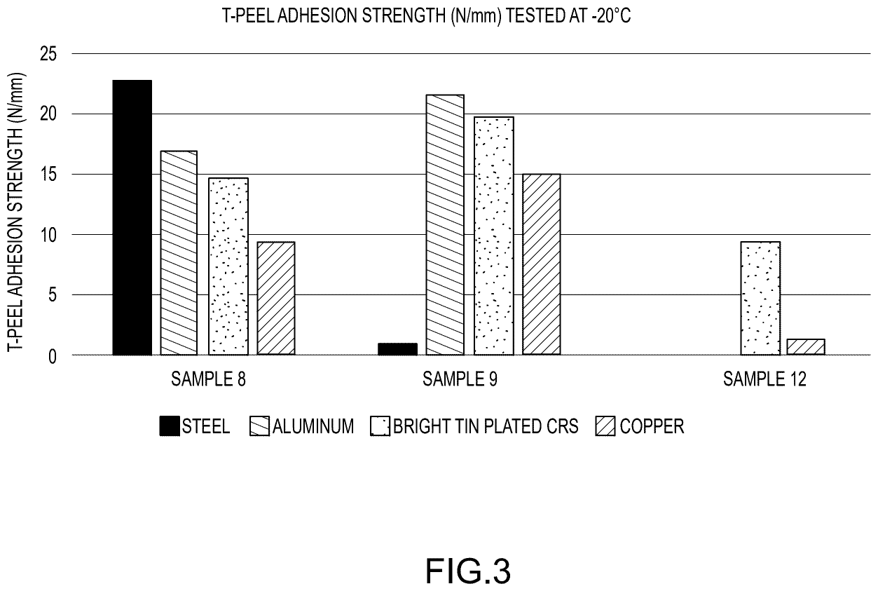

Results are also shown in FIG. 3.

At −20° C., sample 12 is brittle and does not demonstrate peel adhesion strength to steel or aluminum. The adhesion to tin plated CRS and copper is reduced compared to samples 8 and 9. Therefore, the surprising Tg reduction observed in samples 8 and 9 is a property influencing low temperature peel adhesion strength.

At 120° C., the modulus of all compositions is approximately equivalent, except for sample 8. Sample 8, containing the acrylic acid monomer, yields the particularly surprising property of a higher base modulus at elevated temperature, resulting in superior adhesion strength. Sample 9 performs as expected at this temperature.

T-Peel Adhesion Strength (N/mm) Tested at 120° C.

| | sample | | | | |
|---|---|---|---|---|---|
| Substrate | 7 | 8 | 9 | 10 | 11 |
| Steel | 10.9 | 12.1 | 8.9 | 11.0 | 8.3 |
| Aluminum | 8.5 | 13.2 | 7.1 | 7.1 | 4.7 |
| Bright Tin Plated CRS | 6.9 | 13.5 | 7.6 | 7.4 | 6.2 |
| Copper | 7.0 | 17.2 | 9.9 | 7.3 | 8.5 |

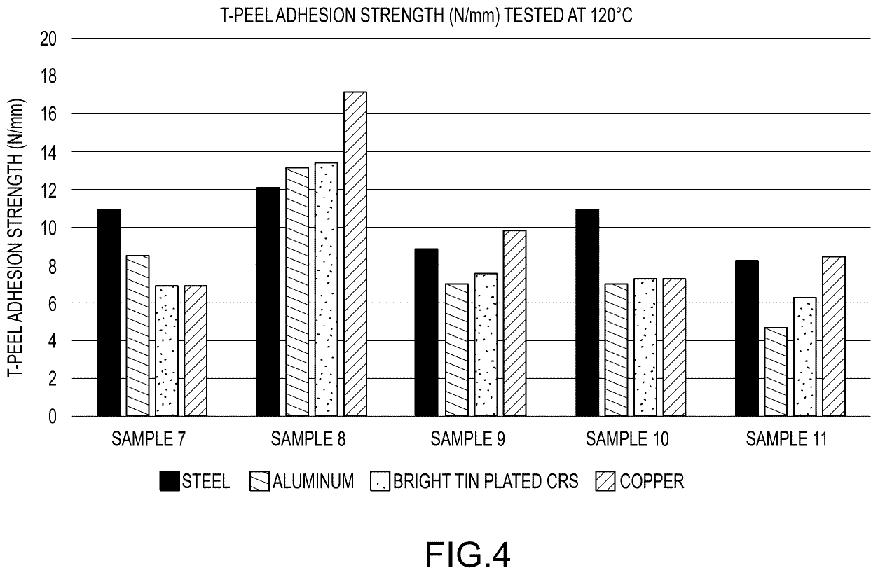

Results are shown in FIG. 4.

In addition to a broad temperature performance, the cured composition in sample 8 also retains adhesive strength after exposure to 85° C. and 85% relative humidity (RH) for 7 days compared to the baseline and similar compositions without the (meth)acrylic acid.

| | Exposure | sample | | | | |
|---|---|---|---|---|---|---|
| Substrate | Condition | 7 | 8 | 9 | 10 | 11 |
| Steel | 23° C. | 12.8 | 16.1 | 17.2 | 7.1 | 8.2 |
| | 7 days at | 13.7 | 19.1 | 5.3 | 7.5 | 4.6 |
| | 85° C. / 85% RH | | | | | |
| % Change | | +7.4% | +18.6% | −68.9% | +6.0% | −44.0% |
| Aluminum | 23° C. | 9.1 | 11.1 | 13.6 | 0.6 | 1.5 |
| | 7 days at | 0 | 8.4 | 3.8 | 5.1 | 0 |
| | 85° C. / 85% RH | | | | | |
| % Change | | −100.0% | −24.3% | −72.1% | +750.0% | −100.0% |
| Bright Tin | 23° C. | 2.5 | 11.7 | 15.2 | 2.5 | 2.2 |
| Plated | 7 days at | 3.6 | 9 | 14.4 | 4.2 | 3.1 |
| CRS | 85° C. / 85% RH | | | | | |
| % Change | | 43.9% | −23.3% | −4.7% | +66.4% | 44.6% |
| Copper | 23° C. | 3.4 | 12.7 | 15.8 | 4.2 | 3.9 |
| | 7 days at | 5.2 | 9.8 | 3.8 | 6.6 | 5.9 |
| | 85° C. / 85% RH | | | | | |

| | | | | | |
|---|---|---|---|---|---|
| % Change | 54.9% | −23.3% | −75.9% | +58.5% | 51.9% |

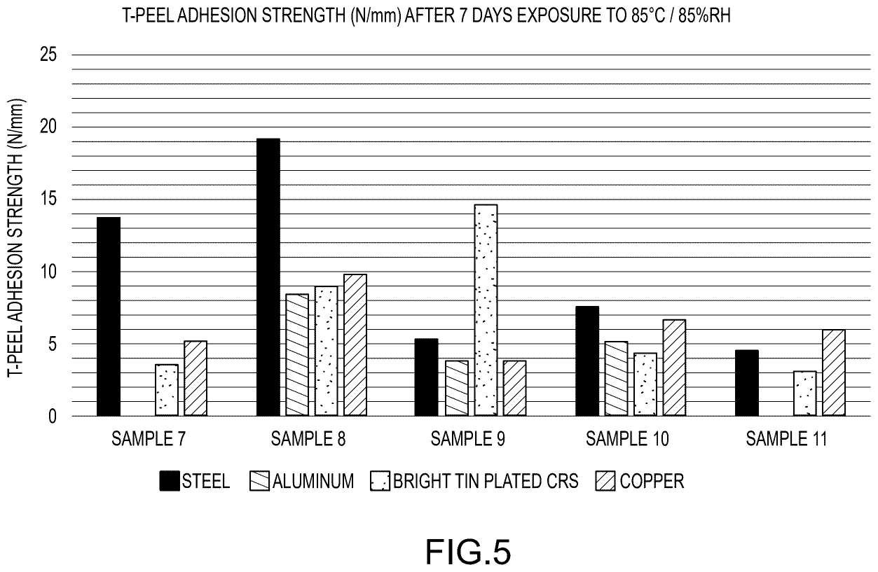

Results are also shown in FIG. 5.

Example 3 shows that acrylic acid used as a plasticizing adhesion promoting monomer in the curable composition has a unique and surprising ability to promote flexibility of the cured reaction products and maintain bonding strength of the cured composition over a broad temperature range. This is unexpected as acrylic acid has a Tg of approximate 106° C. Additionally surprising is the ability of acrylic acid to impart these advantages even after the cured composition is exposed to prolonged high temperature and high humidity exposure.

### Example 4: Ratio of Adhesion Promoting Diluting Monomer to Reactive Monomer Diluent

Curable compositions were prepared from the same (meth)acrylic prepolymer and acrylic acid as the plasticizing adhesion promoting monomer, keeping the total concentration of monomer constant while varying the ratio of the adhesion promoting diluting monomer to the reactive monomer diluent.

Cured T-peel adhesion specimen were prepared and tested with and without exposure to 85° C./85% relative humidity for 7 days. The same substrates from Example 3 were used to prepare specimen for Example 4. All amounts shown below are in grams.

| | sample | | | | | | |
|---|---|---|---|---|---|---|---|
| | 13 | 14 | 15 | 16 | 17 | 18 | 19 |
| (meth)acrylic | 41.0 | 41.0 | 41.0 | 41.0 | 41.0 | 41.0 | 41.0 |
| prepolymer¹ | | | | | | | |
| adhesion promoting | 11.1 | 14.8 | 17.8 | 23.0 | 26.7 | 29.7 | 33.4 |
| diluting monomer² | | | | | | | |
| reactive monomer | 33.4 | 29.7 | 26.7 | 21.5 | 17.8 | 14.8 | 11.1 |
| diluent³ | | | | | | | |
| [Ratio of monomer² | 1:3 | 1:2 | 2:3 | 1:1 | 3:2 | 2:1 | 3:1 |
| to monomer³] | | | | | | | |
| filler⁴ | 7.5 | 7.5 | 7.5 | 7.5 | 7.5 | 7.5 | 7.5 |
| additive⁵ | 1.0 | 1.0 | 1.0 | 1.0 | 1.0 | 1.0 | 1.0 |
| Photoinitiator⁶ | 0.5 | 0.5 | 0.5 | 0.5 | 0.5 | 0.5 | 0.5 |
| plasticizing | 2.0 | 2.0 | 2.0 | 2.0 | 2.0 | 2.0 | 2.0 |
| adhesion | | | | | | | |
| promoting | | | | | | | |
| monomer 1⁷ | | | | | | | |

Adhesion strength values are reported by metal substrate in N/mm.

| | Exposure | sample | | | | | | |
|---|---|---|---|---|---|---|---|---|
| Substrate | Condition | 13 | 14 | 15 | 16 | 17 | 18 | 19 |
| Steel | 23° C. | 16.0 | 16.5 | 17.8 | 16.1 | 14.1 | 12.4 | 12.4 |
| | 7 days at | 5.7 | 9.9 | 2.6 | 19.1 | 19.2 | 20.8 | 6.3 |
| | 85° C. / | | | | | | | |
| | 85% RH | | | | | | | |
| % Change | | −64.4% | −40.0% | −85.4% | +18.6% | +36.2% | +67.7% | −49.2% |
| Aluminum | 23° C. | 12.6 | 12.5 | 15.5 | 11.1 | 10.5 | 10.0 | 10.6 |
| | 7 days at | 3.9 | 8.2 | 5.9 | 8.4 | 14.4 | 8.5 | 5.8 |
| | 85° C. / | | | | | | | |
| | 85% RH | | | | | | | |
| % Change | | −69.0% | −34.4% | −60.4% | −24.3% | +37.1% | −15.0% | −45.3% |
| Bright Tin | 23° C. | 8.1 | 7.9 | 10.8 | 11.7 | 11.3 | 10.9 | 11.4 |
| Plated | 7 days at | 2.7 | 9.7 | 11.1 | 9.0 | 13.0 | 8.2 | 6.5 |
| CRS | 85° C. / | | | | | | | |
| | 85% RH | | | | | | | |
| % Change | | −66.7% | +22.8% | +2.8% | −23.1% | +15.0% | −24.8% | −42.7% |
| Copper | 23° C. | 6.8 | 9.1 | 11.8 | 12.7 | 12.3 | 11.7 | 9.7 |
| | 7 days at | 2.5 | 3.5 | 3.5 | 9.8 | 11.1 | 7.7 | 5.7 |
| | 85° C. / | | | | | | | |
| | 85% RH | | | | | | | |

| | | | | | | | |
|---|---|---|---|---|---|---|---|
| % Change | −63.2% | −61.5% | −70.3% | −22.8% | −9.8% | −34.2% | −41.2% |

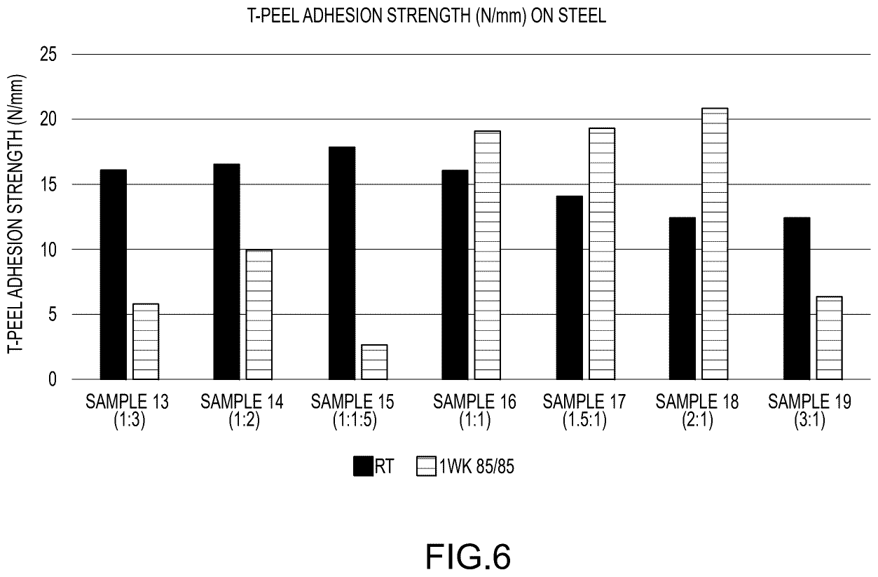

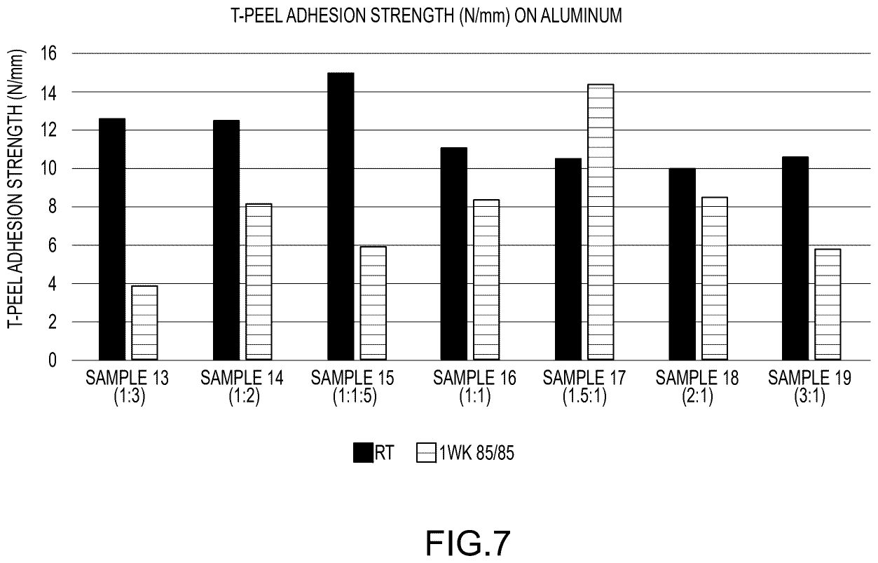

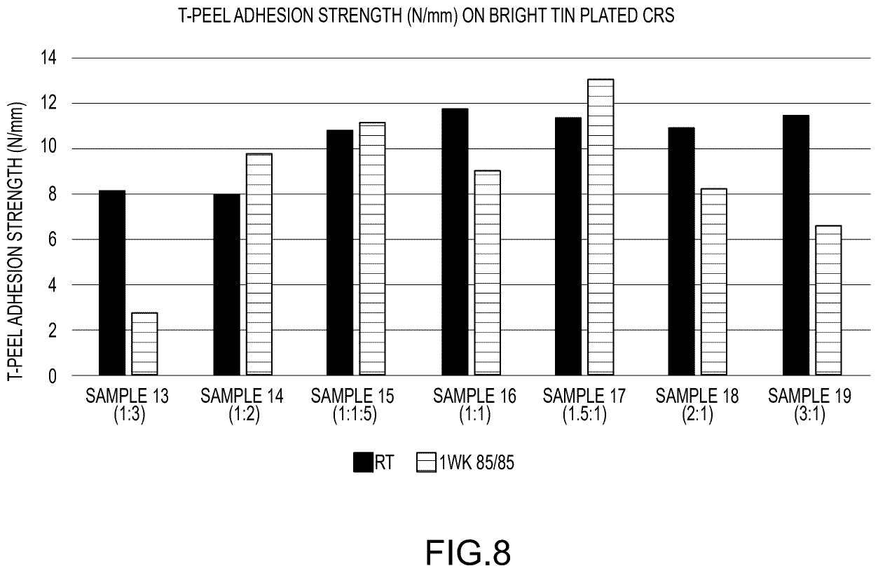

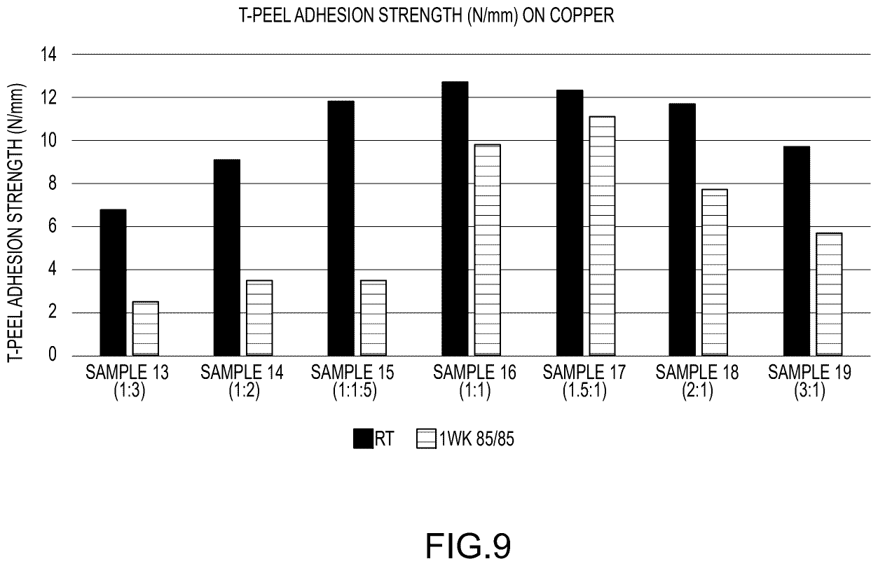

Results are also shown in FIG. 6 (T-Peel strength on steel), FIG. 7 (T-Peel strength on aluminum), FIG. 8 (T-Peel strength on bright tin plated CRS) and FIG. 9 (T-Peel strength on copper)

For metal substrates tested, the optimal ratio of adhesion promoting diluting monomer to reactive monomer diluent is from 1:1 to 2:1, preferably 3:2. When the adhesion promoting diluting monomer concentration lies outside this ratio, the cured reaction product demonstrates a lower peel strength after being subjected to 1 week exposure at 85° C. and 85% relative humidity.

What is claimed:

1. A radiation curable adhesive composition, comprising:
10 wt. % to 99 wt. % of a (meth)acrylic prepolymer;
1 wt. % to 50 wt. % of an adhesion promoting diluting monomer;
0.01 wt. % to 20 wt. % of plasticizing adhesion promoting monomer;
0 wt. % to 50 wt. % of a reactive monomer diluent;
a photoinitiator; and
optionally one or more additives;
wherein the wt. % are by weight of the adhesive composition and total 100.

2. The composition of claim 1 wherein the plasticizing adhesion promoting monomer will be used at a weight ratio of 1 plasticizing adhesion promoting monomer: 4 adhesion promoting diluting monomer to 1 plasticizing adhesion promoting monomer: 20 adhesion promoting diluting monomer.

3. The composition of claim 1 wherein the adhesion promoting diluting monomer will be used at a weight ratio of 3 adhesion promoting diluting monomer: 2 reactive monomer diluent to 1 adhesion promoting diluting monomer: 2 reactive monomer diluent.

4. The composition of claim 1 wherein the adhesion promoting diluting monomer is N,N-dimethylacrylamide.

5. The composition of claim 1 wherein the plasticizing adhesion promoting monomer is (meth)acrylic acid.

6. The composition of claim 1 wherein the monofunctional reactive monomer diluent is isobornyl acrylate.

7. The composition of claim 1 wherein comprising:
20 wt. % to 50 wt. % of a (meth)acrylic prepolymer;
15 wt. % to 30 wt. % of N,N-dimethylacrylamide as the adhesion promoting diluting monomer;
0.1 wt. % to 5 wt. % of (meth)acrylic acid as the plasticizing adhesion promoting monomer; and
5 wt. % to 25 wt. % of monofunctional reactive monomer diluent.

8. The composition of claim 1 comprising at least 0.1 wt. % of an additive.

9. Cured reaction products of the radiation curable adhesive composition of claim 1.

10. An article comprising a radiation curable adhesive composition disposed between a first substrate and a second substrate, wherein the adhesive composition comprises:
10 wt. % to 99 wt. % of a (meth)acrylic prepolymer;
1 wt. % to 50 wt. % of an adhesion promoting diluting monomer;
0.01 wt. % to 20 wt. % of plasticizing adhesion promoting monomer;
0 wt. % to 50 wt. % of a monofunctional reactive monomer diluent; and
a photoinitiator;
wherein the wt. % are by weight of the adhesive composition and total 100.

11. The article of claim 10 wherein the plasticizing adhesion promoting monomer will be used at a weight ratio of 1 plasticizing adhesion promoting monomer: 4 adhesion promoting diluting monomer to 1 plasticizing adhesion promoting monomer: 20 adhesion promoting diluting monomer.

12. The article of claim 10 wherein the adhesion promoting diluting monomer will be used at a weight ratio of 3 adhesion promoting diluting monomer: 2 reactive monomer diluent to 1 adhesion promoting diluting monomer: 2 reactive monomer diluent.

13. The article of claim 10 wherein the adhesion promoting diluting monomer is N,N-dimethylacrylamide.

14. The article of claim 10 wherein the plasticizing adhesion promoting monomer is (meth)acrylic acid.

15. The article of claim 10 wherein the first substrate is polymer and the second substrate is metal.

16. The article of claim 10 wherein the radiation curable adhesive composition comprises at least one additive.

17. The article of claim 10 wherein one of the first substrate or second substrate is transparent to actinic radiation.

18. The article of claim 10 being a transportation component or an electronic device.
